(19) United States
(12) Patent Application Publication
(10) Pub. No.: US 2026/0302424 A1
(43) Pub. Date: Oct. 1, 2026

(54) TEMPERATURE-CONTROL SYSTEM FOR A VEHICLE

(71) Applicant: Eberspächer Sütrak GmbH & Co. KG, Renningen (DE)

(72) Inventor: Tobias Weinreuter, Ilsfeld (DE)

(21) Appl. No.: 19/630,206

(22) Filed: Mar. 26, 2026

(30) Foreign Application Priority Data
Mar. 27, 2025 (DE) 10 2025 111 858.2

(51) Int. Cl. H01M 10/6568; B60H 1/00; B60H 1/14; H01M 10/613; H01M 10/615; H01M 10/625; H01M 50/249

(52) U.S. Cl. CPC H01M 10/6568; B60H 1/00278; B60H 1/143; H01M 10/613; H01M 10/615; H01M 10/625; H01M 50/249; B60H 2001/00307; H01M 2220/20

(57) ABSTRACT

A temperature-control system for a vehicle includes a heating circuit having a heating circuit feed line and a heating circuit return line, a cooling circuit having a cooling circuit feed line and a cooling circuit return line, and a plurality of temperature-control modules. At least two temperature-control modules of the plurality of temperature-control modules, preferably all the temperature-control modules of the plurality of temperature-control modules, each include a first temperature-control module feed line connecting line connected or to be connected to the heating circuit feed line and a first temperature-control module return line connecting line connected or to be connected to the heating circuit return line, or/and a second temperature-control module feed line connecting line connected or to be connected to the cooling circuit feed line and a second temperature-control module return line connecting line connected or to be connected to the cooling circuit return line.

### CROSS-REFERENCE TO RELATED APPLICATIONS

This application claims priority of German patent application no. 10 2025 111 858.2, filed Mar. 27, 2025, the entire content of which is incorporated herein by reference.

### TECHNICAL FIELD

The present disclosure relates to a temperature-control system for a vehicle, with which there is the possibility of thermally conditioning various system regions of a vehicle independently of one another, and which can be easily adapted to different installation environments.

### BACKGROUND

WO 2011/079904A1 has disclosed a temperature-control system for a vehicle, in which there is the possibility of thermally conditioning various system regions of a vehicle that are to be thermally conditioned, such as a vehicle interior, a traction battery and the like. This known temperature-control system includes a compressor providing a temperature-control medium feed pump, by which the refrigerant providing a temperature-control medium is compressed and subsequently supplied via various line regions to various heat exchangers, valves, in particular an expansion valve, in order to dissipate heat from the compressed refrigerant and to utilize the heat to heat one or more system regions, and also absorb heat in the expanded and cooled refrigerant in order to thereby cool system regions.

### SUMMARY

It is an object of the present disclosure to provide a temperature-control system which can be easily adapted to various installation environments in order to thermally condition various system regions independently of one another.

According to the present disclosure, this object is, for example, achieved by a temperature-control system for a vehicle, including:

a heating circuit having a heating circuit feed line and a heating circuit return line,

a cooling circuit having a cooling circuit feed line and a cooling circuit return line,

a plurality of temperature-control modules.

At least two temperature-control modules of the plurality of temperature-control modules, preferably all the temperature-control modules of the plurality of temperature-control modules, each include:

a first temperature-control module feed line connecting line which is connected or is to be connected to the heating circuit feed line and a first temperature-control module return line connecting line which is connected or is to be connected to the heating circuit return line,

or/and

a second temperature-control module feed line connection line which is connected or is to be connected to the cooling circuit feed line and a second temperature-control module return line connection line which is connected or is to be connected to the cooling circuit return line.

The provision of such temperature-control modules or the modular construction of the temperature-control system affords the possibility, depending on the requirements and configuration of a vehicle intended to receive such a temperature-control system, of varying the number of temperature-control modules integrated in the temperature-control system or of adapting to the requirements or the configuration of the vehicle. Since the individual modules of such a temperature-control system are operated independently of one another, there is fundamentally no fluidic or control-related interaction between them, with the result that the addition of one or more additional temperature-control modules or the omission of individual temperature-control modules does not require a fundamental change to the structure of the temperature-control system or when integrating other temperature-control modules. Since the temperature-control medium circulating in the heating circuit or in the cooling circuit includes a conventional, generally liquid heat transfer medium, such as water or the like, the coupling of a temperature-control module to such a circuit is much easier to realize than, for example, the integration of such a temperature-control module in a refrigerant circuit in which a refrigerant having different aggregate states in different regions of the refrigerant circuit circulates.

In order to be able to selectively couple a temperature-control module to the heating circuit or the cooling circuit depending on the heat requirement, each of the at least two temperature-control modules, preferably each temperature-control module, may include a feed switching valve for selectively connecting a temperature-control module inlet line to the first temperature-control module feed line connecting line or to the second temperature-control module feed line connecting line.

Similarly, for the defined conduction of temperature-control medium dispensed from a temperature-control module in that circuit of the heating circuit and cooling circuit from which the temperature-control medium has been received, provision may be made for each of the at least two temperature-control modules, preferably each temperature-control module, to include a return switching valve for selectively connecting a temperature-control module outlet line to the first temperature-control module return line connecting line or to the second temperature-control module return line connecting line.

In order to be able to generate a flow of the temperature-control medium in the individual temperature-control modules independently of other temperature-control modules, each of the at least two temperature-control modules, preferably each temperature-control module, may include a temperature-control medium feed pump for conveying temperature-control medium received via the first temperature-control module feed line connecting line or the second temperature-control module feed line connecting line.

For example, the temperature-control module inlet line may connect an outlet port of the feed switching valve to the temperature-control medium feed pump.

In order to be able to conduct temperature-control medium to or from a respective system region to be thermally conditioned, each of the at least two temperature-control modules, preferably each temperature-control module, may include a temperature-control medium supply line for supplying temperature-control medium to at least one system region to be thermally conditioned and a temperature-control medium discharge line for discharging temperature-control medium from the at least one system region to be thermally conditioned.

In this case, provision may for example be made for the temperature-control medium supply line to connect the temperature-control medium feed pump to the at least one system region to be thermally conditioned.

For defined setting, which is to be performed individually in a respective temperature-control module, of the temperature of the temperature-control medium supplied to a system region to be thermally conditioned, a bypass valve may be provided for selectively conducting at least a portion of the temperature-control medium discharged via the temperature-control medium discharge line from the at least one system region to be thermally conditioned to the temperature-control medium supply line.

In this case, for a constructionally simple structure of a temperature-control module constructed in this way, it may be provided that:

the temperature-control medium discharge line connects the at least one system region to be thermally conditioned to an inlet port of the bypass valve,

the temperature-control module outlet line connects a first outlet port of the bypass valve to an inlet port of the return switching valve,

a bypass line connects a second outlet port of the bypass valve to the temperature-control module inlet line.

A further possibility for setting the temperature of the temperature-control medium within a temperature-control module may provide for a module extension to be provided, assigned to at least one temperature-control module of the at least two temperature-control modules, preferably to each temperature-control module of the at least two temperature-control modules, wherein the module extension includes a branch valve and at least one heat exchanger. With such a heat exchanger, heat can be dissipated to the air surrounding it or be absorbed from it in the case of a comparatively high ambient temperature and the temperature of the temperature-control medium flowing through the at least one heat exchanger can be influenced as a result.

For the integration of such a module extension in a temperature-control module, it is proposed that:

a first line portion of the temperature-control medium discharge line is connected to an inlet port of the branch valve,

a second line portion of the temperature-control medium discharge line is connected to a first outlet port of the branch valve,

a first line portion of a branch line connects a second outlet port of the branch valve to the at least one heat exchanger,

a second line portion of the branch line connects the at least one heat exchanger to the second line portion of the temperature-control medium discharge line.

In this case, for example the second line portion of the temperature-control medium discharge line may connect the first outlet port of the branch valve to the inlet port of the bypass valve.

A simple overall structure of the temperature-control system according to the disclosure can be achieved if the at least two temperature-control modules, preferably all the temperature-control modules, have the same construction. This means that temperature-control modules configured identically to one another in this way contain substantially the same functional components, which, however, do not necessarily have to be arranged in the same spatial relationship to one another or be dimensioned identically to one another. The same construction of the temperature-control modules primarily means that, due to the construction with components that are identical to one another with regard to their function, they can be treated in the same way in terms of control technology and also in relation to the connection to the heating circuit or the cooling circuit.

In order to be able to provide the heat required for system regions to be heated, the heating circuit may include at least one heat source, preferably heating region of a heat pump or/and electrically operated heaters or/and fuel-operated heaters. Similarly, for dissipating heat from system regions to be cooled, the cooling circuit may include at least one heat sink, preferably cooling region of a heat pump.

The at least one system region to be thermally conditioned may, for example, include:

a battery,

at least one powertrain component,

a drive unit,

a vehicle interior.

In this context, it should be noted that of course various system regions to be thermally conditioned may also be provided, assigned to various temperature-control modules, with the result that the temperature of the system regions can be controlled independently of one another according to the respective heating or cooling requirements.

The disclosure further relates to a vehicle, in particular bus, including a temperature-control system constructed according to the disclosure.

### BRIEF DESCRIPTION OF DRAWINGS

The invention will now be described with reference to the drawings wherein:

FIG. 1 shows a diagrammatic illustration of a temperature-control system for a vehicle having a plurality of temperature-control modules; and,

FIG. 2 shows a temperature-control module of the temperature-control system in FIG. 1.

### DETAILED DESCRIPTION

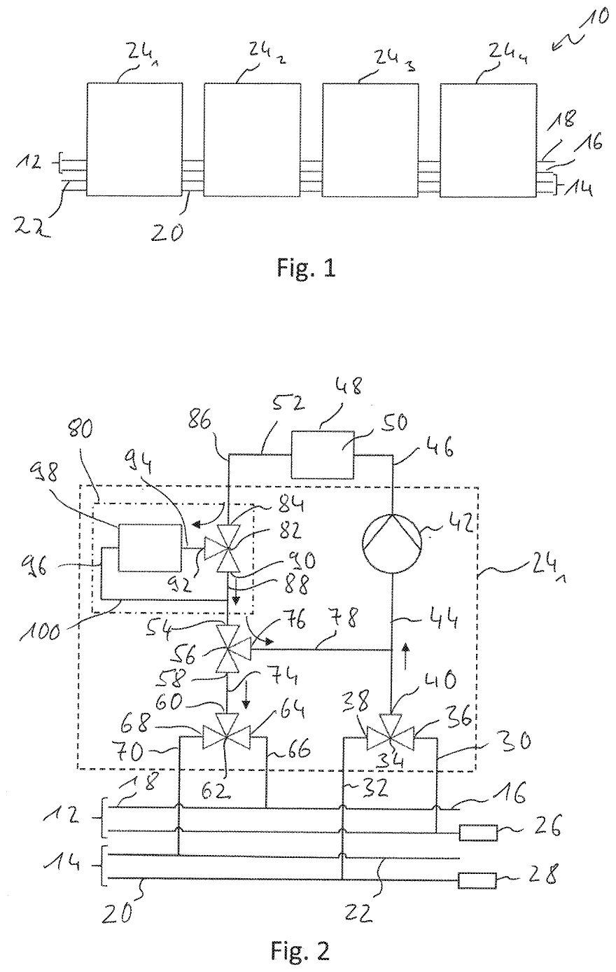

In FIG. 1, a temperature-control system which can be used, for example, for the thermal conditioning of a bus is denoted generally by 10. The temperature-control system 10 includes a heating circuit 12 and a cooling circuit 14. The heating circuit 12 has a heating circuit feed line 16 and a heating circuit return line 18. Similarly, the cooling circuit 14 has a cooling circuit feed line 20 and a cooling circuit return line 22.

A for example liquid temperature-control medium, for example water or the like, which can be heated at a heat source, such as the heating region of a heat pump, that is, the condenser heat exchanger of a refrigerant circuit, an electrically operated or fuel-operated heater or the like, circulates in the heating circuit 12. A for example likewise liquid temperature-control medium, for example water, which can be cooled at a heat sink, for example the cooling region of a heat pump, that is, the region of an evaporator heat exchanger of a refrigerant circuit, circulates in the cooling circuit 14.

The temperature-control system 10 includes a plurality of temperature-control modules 24₁, 24₂, 24₃, 24₄ which can be constructed identically or substantially identically to one another at least in terms of their basic structure and can be utilized for the thermal conditioning in each case of at least one system region to be thermally conditioned of the vehicle by thermal interaction with the heating circuit 12 or the temperature-control medium circulating therein, or with the cooling circuit 14 or the temperature-control medium circulating therein.

The construction of such a temperature-control module is explained by way of example on the basis of the temperature-control module 24₁ illustrated in FIG. 2. Each of the other temperature-control modules 24₂, 24₃, 24₄ may have substantially the same construction as the temperature-control module 24₁ in particular with regard to their basic structure.

FIG. 2 also shows the heating circuit 12 with a heat source 26 assigned thereto. It should be noted that the heating circuit 12 may be assigned a plurality of heat sources 26 which for example also provide heat in various processes. The temperature-control medium circulated by a heating circuit circulation pump in the heating circuit 12 is fed, heated by the at least one heat source 26, into the heating circuit feed line 16 and is conducted back with a lowered temperature to the at least one heat source 26 via the heating circuit return line 28.

FIG. 2 also shows the cooling circuit 14 with a heat sink 28 assigned thereto, from which cooled or cold temperature-control medium is dispensed by a cooling circuit circulation pump into the cooling circuit feed line 20. The cooling circuit 14 may also be assigned a plurality of such heat sinks 28. The temperature-control medium circulating in the cooling circuit 14 flows back via the cooling circuit return line 22 to the at least one heat sink 28.

The temperature-control module 24 has a first temperature-control module feed line connecting line 30 for receiving the temperature-control medium from the heating circuit 12 and has a second temperature-control module feed line connecting line 32 for coupling to the cooling circuit feed line 28. In order to allow heated or cooled temperature-control medium to be selectively received from the heating circuit 12 or the cooling circuit 14, respectively, or fed into the temperature-control module 24₁, a feed switching valve 34 is provided. The first temperature-control module feed line connecting line 30 connects the heating circuit feed line 16 to a first inlet port 36 of the feed switching valve 34. Similarly, the second temperature-control module feed line connecting line 32 connects the cooling circuit feed line 20 to a second inlet port 38 of the feed switching valve 34.

An outlet port 40 of the feed switching valve 34 is adjoined by a temperature-control module inlet line 44 leading to a temperature-control medium feed pump 42. The temperature-control medium feed pump 42 makes it possible, in the temperature-control module 24₁, for the temperature-control medium which is received or is to be received in the module to be conveyed through or, as described below, circulated in the temperature-control module 24₁ independently of the pressure conditions in the heating circuit 12 or cooling circuit 14, respectively.

The temperature-control medium dispensed by the temperature-control medium feed pump 42 flows via a temperature-control medium supply line 46 to a system region 48 to be thermally conditioned which is assigned to the temperature-control module 24₁. A heat exchanger 50 is provided for transferring heat to the system region 48 to be thermally conditioned or for receiving heat from the system region 40 to be thermally conditioned. The heat exchanger 50 may, for example, form a constituent part of the temperature-control module 24₁, that is, be constructionally integrated therein, or may form a constituent part of the system region 48 to be thermally conditioned and be coupled via corresponding connecting regions to the temperature-control module 24₁.

The temperature-control medium leaves the system region 48 to be thermally conditioned or the heat exchanger 50 via a temperature-control medium discharge line 52 and flows via the latter to an inlet port 54 of a bypass valve 56. A first outlet port 58 of the bypass valve 56 is connected via a temperature-control medium outlet line 74 to an inlet port 60 of a return switching valve which is denoted generally by 62. A first outlet port 64 of the return switching valve 62 is connected via a first temperature-control module return line connecting line 66 to the heating circuit return line 18. A second outlet port 68 of the return switching valve 62 is connected via a second temperature-control module return line connecting line 70 to the cooling circuit return line 22.

If the system region 48 to be thermally conditioned is intended to be heated by means of the temperature-control module 24₁, the temperature-control module 24₁ is coupled to the heating circuit 12. For this, the feed switching valve 34 is set such that there is a connection between the first inlet port 36 and the outlet port 40 thereof, whereas there is no connection between the second inlet port 38 and the outlet port 40 thereof. This generates a flow connection between the first temperature-control module feed line connecting line 30 and the temperature-control module inlet line 44. At the same time, the return switching valve 62 is set in such a way that there is a connection between the inlet port 60 and the first outlet port 64 thereof, whereas the second outlet port 68 is shut off, such that there is a flow connection between the temperature-control module outlet line 74 and the first temperature-control module return line connecting line 66. Thus, temperature-control medium received from the heating circuit 12 in the temperature-control module 24₁ can be fed back into the heating circuit 12.

If the system region 48 to be thermally conditioned is intended to be cooled by means of the temperature-control module 24₁, the feed switching valve 34 is switched in such a way that it establishes a flow connection between the outlet port 40 and the second inlet port 38 thereof and thus a flow connection between the temperature-control module inlet line 44 and the second temperature-control module feed line connecting line 32. At the same time, in this state, the return switching valve 62 is switched in such a way that it establishes a flow connection between its inlet port 60 and its second outlet port 70 and thus a flow connection between the temperature-control module outlet line 74 and the cooling circuit return line 22. In this state, the temperature-control medium received from the cooling circuit feed line 20 can be fed back into the cooling circuit 14 or the cooling circuit return line 22 thereof.

The temperature-control module 24₁ further includes a bypass line 78 connected to a second outlet port 76 of the bypass valve 56. This connects the second outlet port 76 of the bypass valve 56 to the temperature-control module inlet line 44. Depending on the setting of the bypass valve 56, there is thus the possibility of circulating all or a portion of the temperature-control medium conveyed by the temperature-control medium feed pump 42 in the temperature-control module 24₁, such that the temperature-control module 24₁ can be operated at least temporarily also decoupled from the heating circuit 12 and from the cooling circuit 14 in order to set the desired temperature in the system region 48 to be thermally conditioned. If the bypass valve 56 is set in such a way that a portion of the temperature-control medium received via the temperature-control medium discharge line 52 in the bypass valve is fed back into the heating circuit 12 or the cooling circuit 14 via the return switching valve 62, whereas the remaining portion is conducted in the direction of the bypass line 78 and thus also in the direction of the temperature-control module inlet line 44, a mixture of temperature-control medium received via the feed switching valve 34 and temperature-control medium circulating in the temperature-control module 24₁ is produced in the temperature-control module inlet line 44, as a result of which the temperature of the temperature-control medium dispensed by the temperature-control medium feed pump 42 can be set according to the temperature-control requirements.

In the embodiment illustrated, the temperature-control module 24 includes a module extension denoted generally by 80. The module extension 80 may be integrated as a fixed constituent part in the temperature-control module 24₁ or may be selectively attached as a further modular assembly to the temperature-control module 24.

The module extension 80 includes a branch valve 82 integrated in the temperature-control medium discharge line 52. An inlet port 84 of the branch valve 82 is connected via a first line portion 86 of the temperature-control medium discharge line 52 to the system region 48 to be thermally conditioned or the heat exchanger 50. Via a second line portion 88 of the temperature-control medium discharge line 52, a first outlet port 90 of the branch valve 82 is connected to the inlet port 54 of the bypass valve 56.

A second outlet port 92 of the branch valve 82 is connected via a first line portion 94 of a branch line 96 to a heat exchanger 98. The heat exchanger 98 is coupled via a second line portion 100 of the branch line 96 to the second line portion 88 of the temperature-control medium discharge line 52.

Depending on the setting of the branch valve 82, the temperature-control medium dispensed via the temperature-control medium discharge line 52 from the system region 48 to be thermally conditioned or from the heat exchanger 50 can selectively be conducted into the heat exchanger 98 or directly in the direction of the bypass valve 56, or a portion of the temperature-control medium flowing through the first line portion 86 of the temperature-control medium discharge line 52 may be conducted in the direction of the heat exchanger 98, whereas the remaining portion may be conducted in the direction of the bypass valve 56.

By selectively conducting at least a portion of the temperature-control medium through the heat exchanger 98, there is the possibility of influencing the temperature thereof. For example, the temperature-control medium at the heat exchanger 98 may transfer heat to the air surrounding it and thus flow cooled in the direction of the bypass valve 56, or may absorb heat in the case of a comparatively high ambient temperature and thus flow heated in the direction of the bypass valve 56. This can then, as described above, depending on the thermal conditioning requirements, conduct at least a portion of the temperature-control medium flowing therein back in the direction of the temperature-control module inlet line 44.

The possibility of heating or cooling at least a portion of the temperature-control medium flowing through the temperature-control module 24₁ at the heat exchanger 98 and of being able to conduct at least a portion of the temperature-control medium received in the bypass valve 56 via the bypass line 78 to the temperature-control module inlet line 44 and via the latter in the direction of the system region 48 to be thermally conditioned affords the possibility of achieving exact temperature regulation in the region of the system region 48 to be thermally conditioned. To this end, one or more temperature sensors can be used to measure the temperature in the region of the system region 48 to be thermally conditioned, and taking this temperature into account, the system regions under the control of a control unit, that is, essentially the feed switching valve 34, the temperature-control medium feed pump 42, the branch valve 82, the bypass valve 56 and the return switching valve 62, can be set such that the temperature of the temperature-control medium conducted via the temperature-control medium supply line 46 to the heat exchanger 50 is set such that the system region 48 to be thermally conditioned is rapidly brought to the temperature intended for this or is kept at this temperature.

Since, to this end, it is possible to decouple the temperature-control module 24₁ at least partially from the heating circuit 12 and from the cooling circuit 14, efficient operation for the heating or cooling of the system region 48 to be thermally temperature-controlled can be achieved, wherein each temperature-control module constructed in this way can be operated independently of other temperature-control modules integrated in the temperature-control system 10. In conjunction with each of the temperature-control modules 24₁, 24₂, 24₃, 24₄, there is thus the possibility of bringing the respectively assigned system region to be thermally conditioned to the intended temperature or of keeping it at the temperature in an optimal manner and independently of the operation in the respective other temperature-control modules.

The modular construction of the temperature-control system allows not only the thermal conditioning of various system regions substantially independently of one another, but also allows the entire temperature-control system to be easily adapted to various installation environments. For example, depending on the size or configuration of a vehicle, for example bus, intended to receive the temperature-control system, the number of temperature-control modules can be varied. It is for example possible in the case of an electrically operated vehicle to provide a temperature-control module in order to thermally condition, that is, to heat or cool depending on the operating state, a traction battery, whereas such a temperature-control module is not present in the case of a vehicle configured with a fuel-based drive unit.

However, the integration of different numbers of such temperature-control modules in the temperature-control system does not affect the basic structure of the temperature-control modules themselves which are assigned to the various system regions to be heated or cooled. All these temperature-control modules may, for example, be constructed the same basic structure with the temperature-control medium feed pump and the possibility of coupling it to the heating circuit or the cooling circuit. If for a system region to be thermally conditioned there is the need to have to selectively heat or cool the latter, it is possible in the case of a temperature-control module provided for this, through use of the switching valves, to ensure that it can be selectively coupled to the heating circuit and the cooling circuit. If there is the need to have to achieve a sensitive, exact temperature setting for the system region to be thermally conditioned, provision of the module extension in a manner assigned to a temperature-control module or/and provision of a bypass valve enabling module-internal circulation of the temperature-control medium can ensure that temperature-control medium flows of different temperatures are mixed in order to thus be able to exactly provide the temperature of the temperature-control medium that is required or advantageous for the required thermal conditioning. This means that, in the case of such temperature-control modules, the module extension, the bypass valve and the bypass line assigned thereto, and also the two switching valves, can be considered as optional assemblies which can be provided in any combination in such a module depending on the requirements or configuration of the system region to be thermally conditioned.

Of course, depending on the respective application, the various components of such temperature-control modules may be arranged differently relative to one another or also be dimensioned differently. For example, for the individual modules, the size of the temperature-control medium feed pump may be selected depending on the amount of temperature-control medium required for the thermal conditioning of a respectively assigned system region. This also contributes to being able to operate various system regions to be thermally conditioned at different temperature levels in a vehicle, such as a bus, and ensuring, in conjunction with each of these system regions to be thermally conditioned and the temperature-control modules assigned thereto, the most efficient operation through corresponding control of the various valves.

It is understood that the foregoing description is that of the preferred embodiments of the invention and that various changes and modifications may be made thereto without departing from the spirit and scope of the invention as defined in the appended claims.

1. A temperature-control system for a vehicle, the temperature-control system comprising:
a heating circuit having a heating circuit feed line and a heating circuit return line;
a cooling circuit having a cooling circuit feed line and a cooling circuit return line;
a plurality of temperature-control modules, wherein at least two temperature-control modules of said plurality of temperature-control modules each include at least one of:
a first temperature-control module feed line connecting line which is connected or is configured to be connected to said heating circuit feed line and a first temperature-control module return line connecting line which is connected or is configured to be connected to said heating circuit return line; and,
a second temperature-control module feed line connecting line which is connected or is configured to be connected to said cooling circuit feed line and a second temperature-control module return line connecting line which is connected or is configured to be connected to said cooling circuit return line.

2. The temperature-control system of claim 1, wherein each of said at least two temperature-control modules includes a feed switching valve for selectively connecting a temperature-control module inlet line to said first temperature-control module feed line connecting line or to said second temperature-control module feed line connecting line.

3. The temperature-control system of claim 1, wherein each of said at least two temperature-control modules includes a return switching valve for selectively connecting a temperature-control module outlet line to said first temperature-control module return line connecting line or to said second temperature-control module return line connecting line.

4. The temperature-control system of claim 1, wherein each of said at least two temperature-control modules includes a temperature-control medium feed pump for conveying temperature-control medium received via said first temperature-control module feed line connecting line or said second temperature-control module feed line connecting line.

5. The temperature-control system of claim 4, wherein each of said at least two temperature-control modules includes a feed switching valve for selectively connecting a temperature-control module inlet line to said first temperature-control module feed line connecting line or to said second temperature-control module feed line connecting line; and, said temperature-control module inlet line connects an outlet port of said feed switching valve to said temperature-control medium feed pump.

6. The temperature-control system of claim 1, wherein each of said at least two temperature-control modules includes a temperature-control medium supply line for supplying temperature-control medium to at least one system region to be thermally conditioned and a temperature-control medium discharge line for discharging the temperature-control medium from the at least one system region to be thermally conditioned.

7. The temperature-control system of claim 4, wherein each of said at least two temperature-control modules includes a temperature-control medium supply line for supplying temperature-control medium to at least one system region to be thermally conditioned and a temperature-control medium discharge line for discharging the temperature-control medium from the at least one system region to be thermally conditioned; and, said temperature-control medium supply line connects said temperature-control medium feed pump to the at least one system region to be thermally conditioned.

8. The temperature-control system of claim 6 further comprising a bypass valve for selectively conducting at least a portion of the temperature-control medium discharged via said temperature-control medium discharge line from the at least one system region to be thermally conditioned to said temperature-control medium supply line.

9. The temperature-control system of claim 8, wherein:
each of said at least two temperature-control modules includes a feed switching valve for selectively connecting a temperature-control module inlet line to said first temperature-control module feed line connecting line or to said second temperature-control module feed line connecting line;
each of said at least two temperature-control modules includes a return switching valve for selectively connecting a temperature-control module outlet line to said first temperature-control module return line connecting line or to said second temperature-control module return line connecting line;
said temperature-control medium discharge line connects the at least one system region to be thermally conditioned to an inlet port of said bypass valve;
said temperature-control module outlet line connects a first outlet port of said bypass valve to an inlet port of said return switching valve; and,
a bypass line connects a second outlet port of said bypass valve to said temperature-control module inlet line.

10. The temperature-control system of claim 1 further comprising:
a module extension assigned to at least one temperature-control module of said at least two temperature-control modules; and,
said module extension includes a branch valve and at least one heat exchanger.

11. The temperature-control system of claim 10, wherein:
each of said at least two temperature-control modules includes a temperature-control medium supply line for supplying temperature-control medium to at least one system region to be thermally conditioned and a temperature-control medium discharge line for discharging the temperature-control medium from the at least one system region to be thermally conditioned;
a first line portion of said temperature-control medium discharge line is connected to an inlet port of said branch valve;
a second line portion of said temperature-control medium discharge line is connected to a first outlet port of said branch valve;
a first line portion of a branch line connects a second outlet port of said branch valve to said at least one heat exchanger; and,
a second line portion of the branch line connects said at least one heat exchanger to said second line portion of said temperature-control medium discharge line.

12. The temperature-control system of claim 9 further comprising:
a module extension assigned to at least one temperature-control module of said at least two temperature-control modules;
said module extension includes a branch valve and at least one heat exchanger;
each of said at least two temperature-control modules includes a temperature-control medium supply line for supplying the temperature-control medium to the at least one system region to be thermally conditioned and a temperature-control medium discharge line for discharging the temperature-control medium from the at least one system region to be thermally conditioned;
a first line portion of said temperature-control medium discharge line is connected to an inlet port of said branch valve;
a second line portion of said temperature-control medium discharge line is connected to a first outlet port of said branch valve;
a first line portion of a branch line connects a second outlet port of said branch valve to said at least one heat exchanger;
a second line portion of the branch line connects said at least one heat exchanger to said second line portion of said temperature-control medium discharge line; and,
said second line portion of said temperature-control medium discharge line connects said first outlet port of said branch valve to said inlet port of said bypass valve.

13. The temperature-control system of claim 1, wherein said at least two temperature-control modules have an identical construction.

14. The temperature-control system of claim 1, wherein at least one of:
said heating circuit includes at least one heat source; and
said cooling circuit includes at least one heat sink.

15. The temperature-control system of claim 14, wherein at least one of:
said at least one heat source is at least one of a heating region of a heat pump, an electrically operated heater, and a fuel operated heater; and,
said at least one heat sink is a cooling region of a heat pump.

16. The temperature-control system of claim 6, wherein the at least one system region to be thermally conditioned includes:
a battery,
at least one powertrain component,
a drive unit, and,
a vehicle interior.

17. The temperature-control system of claim 1, wherein all of said plurality of temperature control modules includes at least one of said first temperature-control module feed line connecting line and said second temperature-control module feed line connecting line.

18. A vehicle comprising:
a temperature-control system including a heating circuit and a cooling circuit;
said heating circuit having a heating circuit feed line and a heating circuit return line;
said cooling circuit having a cooling circuit feed line and a cooling circuit return line;
said temperature-control system further including a plurality of temperature-control modules, wherein at least two temperature-control modules of said plurality of temperature-control modules each include at least one of:
a first temperature-control module feed line connecting line which is connected or is configured to be connected to said heating circuit feed line and a first temperature-control module return line connecting line which is connected or is configured to be connected to said heating circuit return line; and,
a second temperature-control module feed line connecting line which is connected or is configured to be connected to said cooling circuit feed line and a second temperature-control module return line connecting line which is connected or is configured to be connected to said cooling circuit return line.

19. The vehicle of claim 18, wherein the vehicle is a bus.
